(19) United States
(12) Patent Application Publication
(10) Pub. No.: US 2018/0140402 A1
(43) Pub. Date: May 24, 2018

(54) HIGH-PRESSURE-WATER TOOTHBRUSH AND U-SHAPED JET-WASHING GROOVE STRUCTURE THEREOF

(71) Applicant: O-Ming CHU, Taipei City (TW)

(72) Inventor: O-Ming CHU, Taipei City (TW)

(21) Appl. No.: 15/876,375

(22) Filed: Jan. 22, 2018

Related U.S. Application Data
(63) Continuation of application No. PCT/CN2016/000582, filed on Oct. 24, 2016.
Application No. PCT/CN2016/000582 is a continuation of application No. PCT/CN2017/000688, filed on Nov. 15, 2017.

(51) Int. Cl. A61C 17/02; A46B 9/04; A46B 11/06

(52) U.S. Cl. CPC A61C 17/0211; A61C 17/0202; A46B 2200/1066; A46B 11/06; A46B 9/045

(57) ABSTRACT

The present invention provides a high-pressure-water toothbrush and a U-shaped jet-washing groove structure thereof, comprising: a handle and a U-shaped jet-washing groove provided at an end of the handle. The U-shaped jet-washing groove structure has a first sidewall and a second sidewall facing the first sidewall, and each of the first sidewall and the second sidewall has an inner wall surface provided with a plurality of nozzles. By the implementation of the present invention, the insides and outsides of the teeth surfaces and teeth gaps can be simultaneously flush for the purpose of quick and effective to cleaning the teeth.

### BACKGROUND OF THE INVENTION

### 1. Technical Field

The present invention relates to a toothbrush that utilizes high-pressure water and also to its U-shaped jet-washing groove structure. More particularly, the invention relates to a high-pressure-water toothbrush that can clean the inner and outer sides of teeth simultaneously using a U-shaped jet-washing groove structure and an adjustable high-pressure water flow, and to the U-shaped jet-washing groove structure itself.

### 2. Description of Related Art

Due to social development and the enhancement of living standards, people have paid more and more attention to the appearance and health of teeth. Dental hygiene and health are important because of their role in the betterment of physical and mental health and hence of the quality of life, simply considering the fact that clean and healthy teeth not only reflect a good physical condition, but also contribute favorably to one's image.

Congenital factors aside, the greatest threats to the appearance integrity and health of teeth are the bacteria and microbial plaque on the tooth surface. To maintain oral hygiene and dental health, therefore, various products were developed to remove such bacteria and dental plaque.

Most of the existing teeth-cleaning products depend on friction with the tooth surface to achieve the intended cleaning effect. This friction-based cleaning method, however, may wear away or injure the tooth surface or gum. Moreover, the same method cannot remove bacteria or dental plaque from between the teeth thoroughly, and in order to remove the bacteria or dental plaque, greater pressure must be applied for greater friction, which nevertheless causes further damage to the teeth, resulting in a viscous circle.

In view of the above, it is imperative to develop a teeth-cleaning method that is not friction-based but can clean teeth and improve dental health effectively.

### BRIEF SUMMARY OF THE INVENTION

The present invention provides a high-pressure-water toothbrush and its U-shaped jet-washing groove structure, the primary objective being to wash the inner and outer sides of teeth or gum simultaneously with a washing liquid at a suitable pressure.

The present invention provides a high-pressure-water toothbrush, comprising: a handle provided therein with a first channel; and a U-shaped jet-washing groove structure provided at an end of the handle and provided therein with a second channel in communication with the first channel, wherein the U-shaped jet-washing groove structure has a first sidewall and a second sidewall facing the first sidewall, and each of the first sidewall and the second sidewall has an inner wall surface provided with a plurality of nozzles.

The present invention provides a U-shaped jet-washing groove structure, comprising a first sidewall and a second sidewall facing the first sidewall, wherein each of the first sidewall and the second sidewall has an inner wall surface provided with a plurality of nozzles.

Implementation of the invention at least produces the following advantageous effects:
1. The inner and outer sides of teeth or gum can be washed and cleaned at the same time.
2. Hydro massage can be performed on the inner and outer sides of gum simultaneously.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

FIG. 1A is a perspective view in which two high-pressure-water toothbrushes according to the present invention are coupled to the main machine;

FIG. 1B is a cutaway perspective view of the main machine in FIG. 1;

FIG. 2 is a perspective view of a high-pressure-water toothbrush according to the invention, wherein the toothbrush includes a mirror-symmetric U-shaped jet-washing groove structure;

FIG. 3A shows an embodiment of the U-shaped jet-washing groove structure in FIG. 2 that has a spiral groove formed in the bore wail of at least one of the nozzles;

FIG. 3B shows embodiment of the U-shaped jet-washing groove structure in FIG. 2 that has a spiral duct provided in at least one of the nozzles;

FIG. 3C shows an embodiment of the U-shaped jet-washing groove structure in FIG. 2 that has a plurality of bristles formed beside at least one of the nozzles;

FIG. 4A is a top view of a high-pressure-water toothbrush according to the invention, wherein the toothbrush includes a full-dental-arch jet-washing structure;

FIG. 4B is a bottom view of the high-pressure-water toothbrush in FIG. 4A;

FIG. 4C is a side view of the high-pressure-water toothbrush in FIG. 4A;

FIG. 4D is a front view of the high-pressure-water toothbrush in FIG. 4A; and

FIG. 4E shows a state of use of the high-pressure-water toothbrush in FIG. 4A.

### DETAILED DESCRIPTION OF THE INVENTION

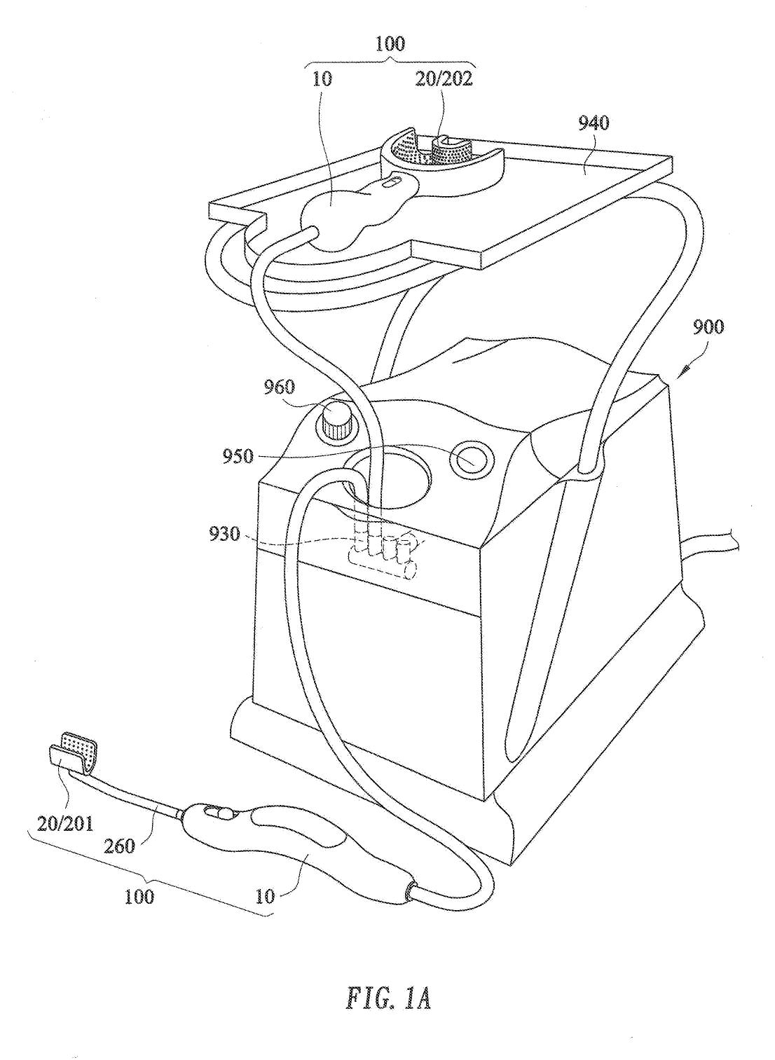

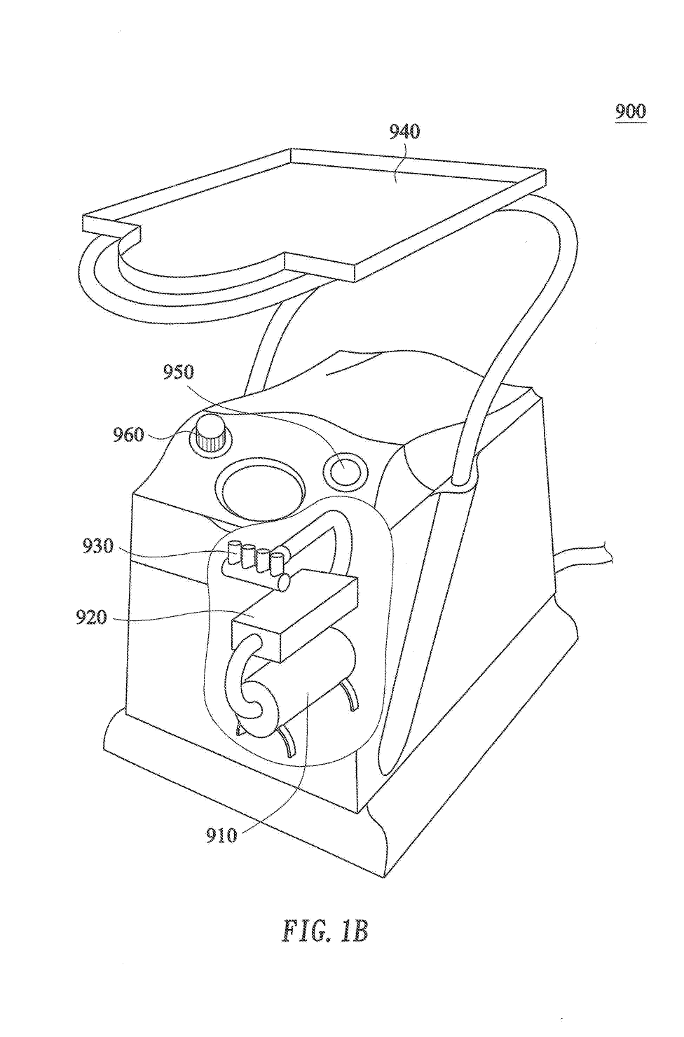

FIG. 1A shows two embodiments of the high-pressure-water toothbrush 100 of the present invention. Each high-pressure-water toothbrush 100 includes a handle 10 and a U-shaped jet-washing groove structure 20 and is coupled to a main machine 900 (see also FIG. 1B) in order to be used.

The main machine 900 is provided therein with a hydraulic pump 910. The hydraulic pump 910 receives water from an external source and outputs water at a pressure of 1.0˜5.0 kg/cm² to produce the desired cleaning effect while ensuring comfort and safety. The hydraulic pump 910 may be connected in series to a water activation module 920 so that the water output from the hydraulic pump 910 goes through multi-stage activation and sterilization before it is ejected as water jets to wash teeth. The activated and sterilized water helps increase the teeth-cleaning effect.

To facilitate use by different members of the same family, the main machine 900 may be provided with a plurality)f water outlets 930. Each family member can therefore connect their own high-pressure-water toothbrush 100 to one of the water outlets 930 in order to supply the toothbrush with washing water while other family members do the same. In addition, the main machine 900 may be coupled with a tray or rack 940 on which to place the high-pressure-water toothbrushes 100 after use.

To facilitate operation, the main machine 900 is provided with a main switch 950 for turning on and off the hydraulic pump 910. The main machine 900 may also be provided with an adjustment knob 960 for adjusting the pressure of washing liquid as appropriate. More specifically, a user can control the hydraulic pump 910 through the adjustment knob 960 in order for the hydraulic pump 910 to output washing liquid at a certain pressure within a predetermined range.

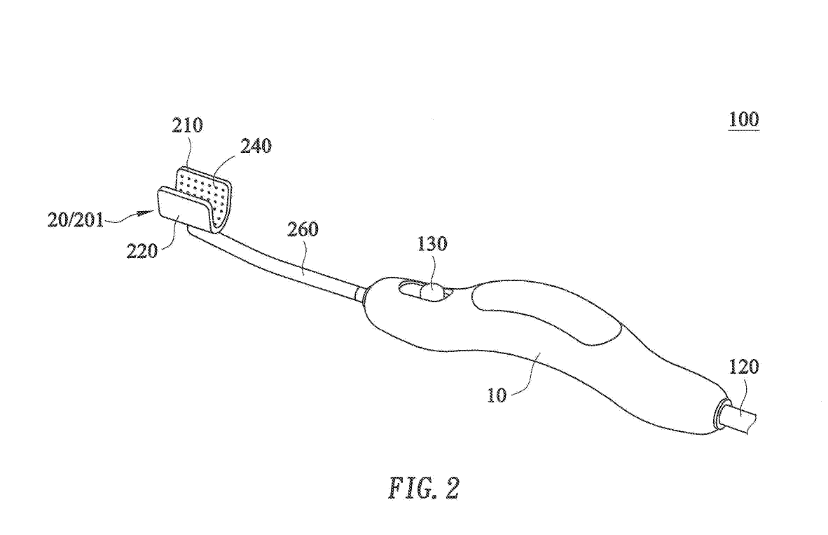

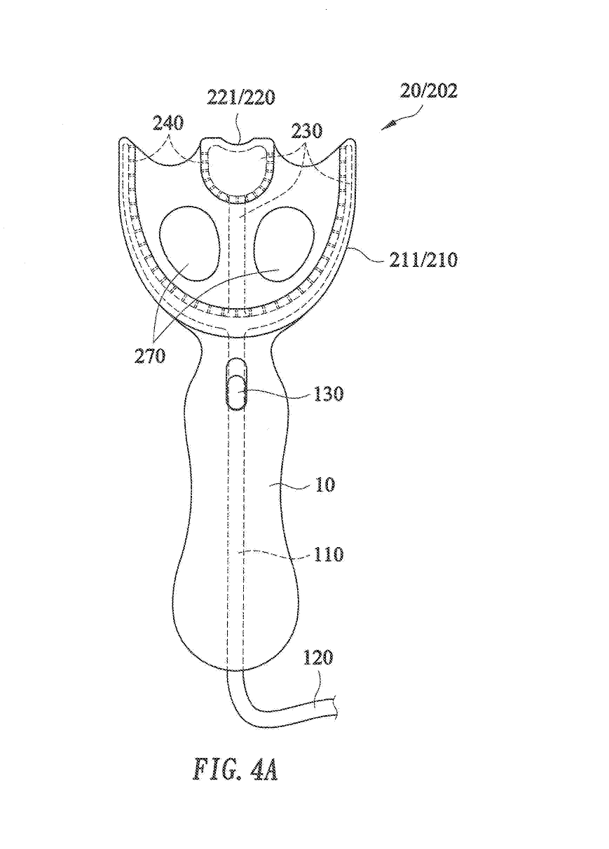

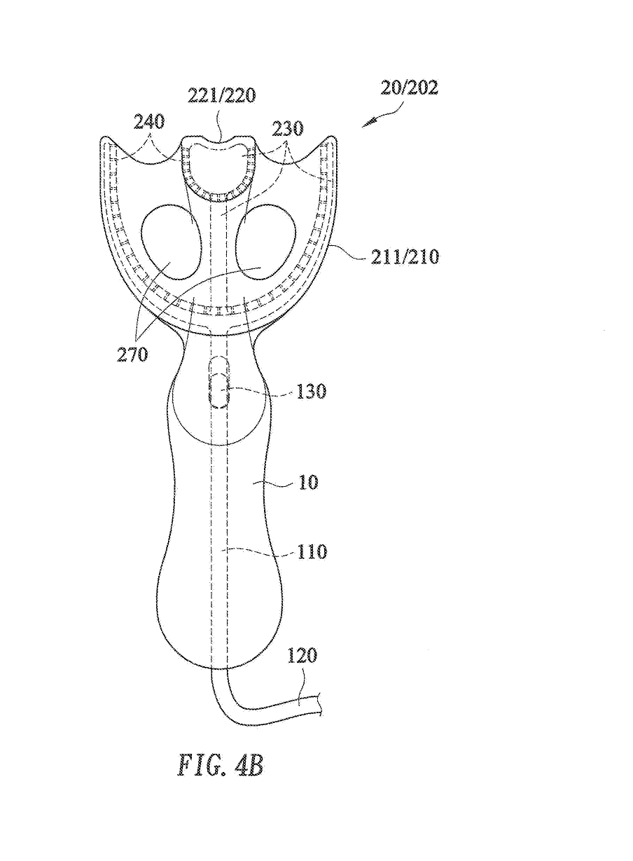

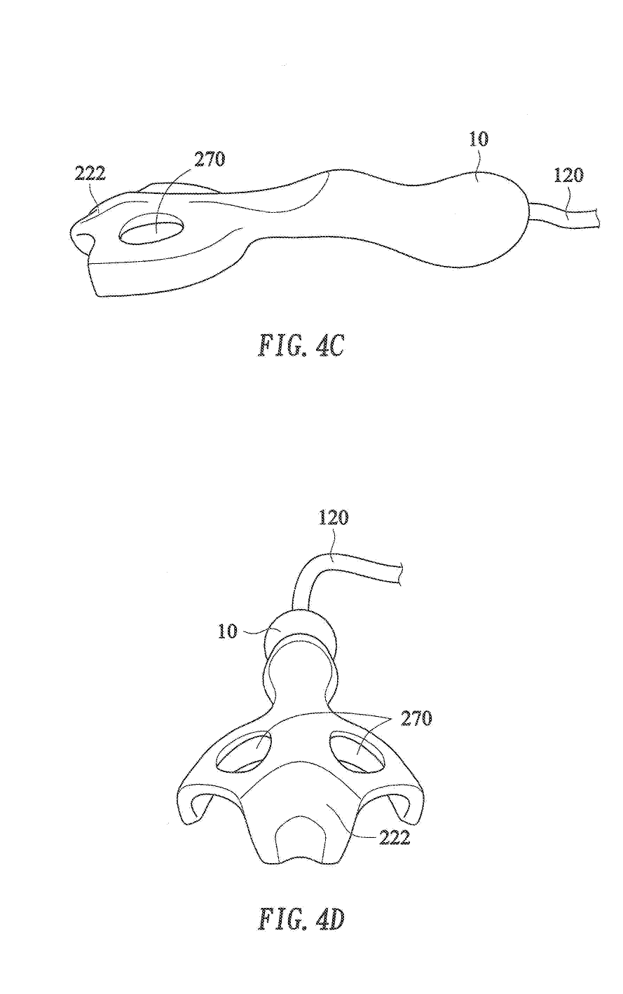

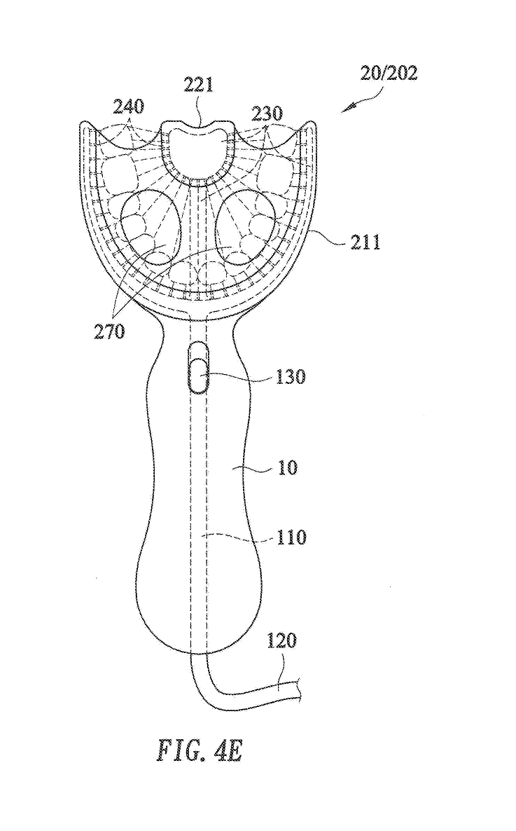

As shown in FIG. 2, the handle 10 is ergonomically shaped and serves mainly to be gripped by a user so that the user can operate the high-pressure-water toothbrush 100 with ease. The handle 10 is provided therein with a first channel 110 (see FIG. 4A). The first channel 110 has an input end configured to communicate with any of the water outlets 930 through a tube 120 and thereby enable the first channel 110 to receive the pressurized washing liquid output from the hydraulic pump 910.

In order for a user to easily control the pace at which to wash teeth, the handle 10 may be provided with a water switch 130 at a position reachable by the user's thumb or index finger. The water switch 130 is connected to the first channel 110 and is configured to open and close the first channel 110, allowing the user to control the pace of teeth washing while holding the handle 10.

The U-shaped jet-washing groove structure 20 is provided at one end of the handle 10 and is provided therein with a second channel 230. The second channel 230 is in communication with the first channel 110 (see FIG. 4A) so that washing water in the first channel 110 can flow through the second channel 230 to each nozzle 240.

The U-shaped jet-washing groove structure 20 has a first sidewall 210 and a second sidewall 220 that face each other. The inner wall surface of the first sidewall 210 is provided with a plurality of nozzles 240, and so is the inner wall surface of the second sidewall 220.

The first sidewall 210 and the second sidewall 220 may form a mirror-symmetric structure 201. The provision of the first sidewall 210 and the second sidewall 220 makes it possible to wash the inner and outer sides of teeth and the gaps between teeth at the same time. The teeth and gum, therefore, can be cleaned rapidly and effectively.

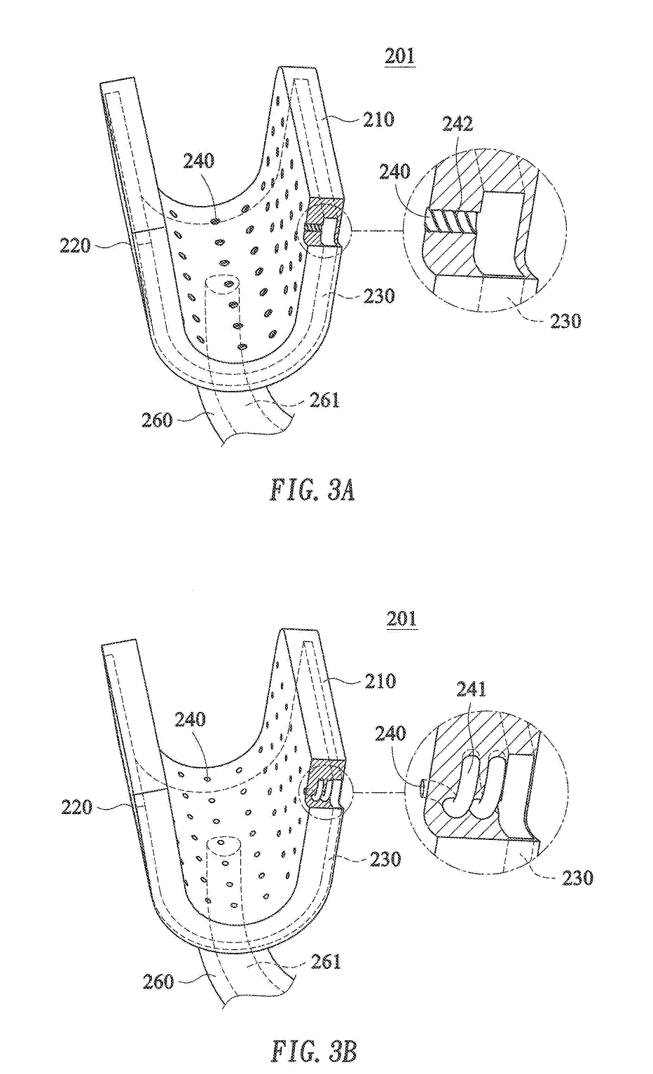

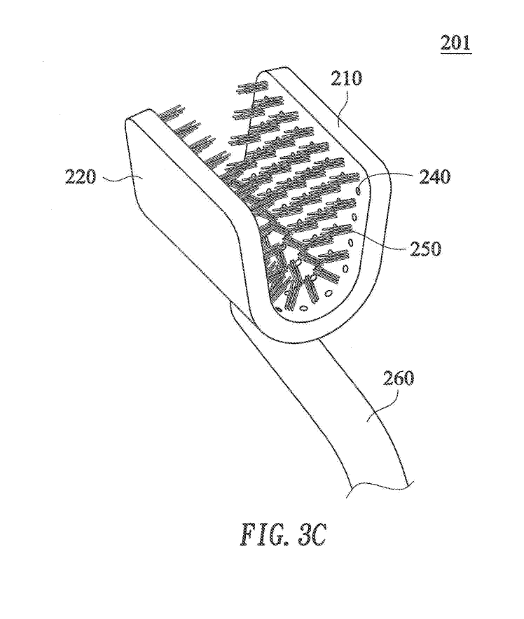

Referring to FIG. 3A and FIG. 3B, the nozzles 240 serve mainly to provide pressurized water jets for washing the font sides, rear sides, and gaps of teeth effectively. To enhance the washing effect, at least one of the nozzles 240 may be designed as a spiral duct 241, or the bore wall of at least one of the nozzles 240 may have a spiral groove 242 similar to those in a rifle barrel; in either case, the objective is to render the washing liquid into a spinning water jet for better cleaning effect.

Furthermore, referring to FIG. 3C, a plurality of bristles 250 may be provided beside at least one of the nozzles 240 of the U-shaped jet-washing groove structure 20 so that washing liquid can interact with the bristles 250 to produce a different cleaning effect.

When the U-shaped jet-washing groove structure 20 is a mirror-symmetric structure 201 as shown in FIG. 1A, FIG. 3A, FIG. 3B, and FIG. 3C, an extension tube 260 may be additionally provided to facilitate placement of the U-shaped jet-washing groove structure 20 deep into the oral cavity. The extension tube 260 connects the handle 10 and the U-shaped jet-washing groove structure 20 and is provided therein with a third channel 261. The third channel 261 is configured to communicate with the first channel 110 and the second channel 230.

To use the high-pressure-water toothbrush 100, the first sidewall 210 and the second sidewall 220 of the U-shaped jet-washing groove structure 20 are placed on two opposite sides of the upper or lower row of teeth respectively. Once water jets are ejected from the nozzles 240, the user may move the U-shaped jet-washing groove structure 20 slightly in the forward/rearward and leftward/rightward directions by manipulating the handle 10, in order to clean the teeth and gum rapidly and effectively.

As an alternative to the mirror-symmetric structure 201 described above, the U-shaped jet-washing groove structure 20 may be designed as a full-dental-arch jet-washing structure 202 as shown in FIG. 4A to FIG. 4E. In this full-dental-arch configuration, the first sidewall 210 is designed, as a dental arch-shaped structure 211 whose curvature generally matches those of the upper and lower dental arches, and the second sidewall 220 is designed as a fan-shaped jet-ejecting structure 221 that is adapted to be placed deep into the oral cavity and that can eject water jets in a radial manner to the inner sides of a row of teeth simultaneously.

When using the full-dental-arch jet-washing structure 202, which can be viewed as a different version of the U-shaped jet-washing groove structure 20, the U-shaped jet-washing groove structure 20 can cover the inner and outer sides of an entire row of teeth at once. As the oral area that can be covered in one go is much larger than that achievable with the original U-shaped jet-washing groove structure 20, the full-dental-arch jet-washing structure 202 is especially suitable for the elderly and those with certain physical disabilities.

To facilitate movement of the U-shaped jet-washing groove structure 20 into and out of the oral cavity, the backside of the second sidewall 220 of the U-shaped jet-washing groove structure 20 may be designed as an inclined surface 222 that slopes from an inner portion toward an outer portion, with a view to reducing unnecessary friction between the second sidewall 220 and the tongue, teeth, or palate while the second sidewall 220 enters or leaves the oral cavity.

In addition, the middle wall portion of the U-shaped jet-washing groove structure 20 may be provided with a plurality of drain holes 270 so that water can easily discharge from the U-shaped jet-washing groove structure 20. During the teeth cleaning process, a large amount of water is used for cleaning, and some of the used cleaning water will accumulate in between the first sidewall 210 and the second sidewall 220. The drain holes 270 in the middle wall portion of the U-shaped jet-washing groove structure 20 enable effective removal of the accumulated water, which, if left as is, may hinder subsequent jet-washing operation or even choke the user as it flows into the user's throat

Referring back to FIG. 3A to FIG. 3C, the full-dental-arch jet-washing structure 202, which can be viewed as a different version of the U-shaped jet-washing groove structure 20, may also have at least one of its nozzles 240 designed as a spiral, duct 241 or as having a spiral groove 242 in the bore wall. By the same token, a plurality of bristles 250 may be formed beside at least one of the nozzles 240 of the full-dental-arch jet-washing structure 202.

The embodiments described above are intended only to demonstrate the technical concept and features of the present invention so as to, enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A high-pressure-water toothbrush, comprising:
a handle provided therein with a first channel; and
a U-shaped jet-washing groove structure provided at an end of the handle and provided therein with a second channel in communication with the first channel, wherein the U-shaped jet-washing groove structure has a first sidewall and a second sidewall facing the first sidewall, and each of the first sidewall and the second sidewall has an inner wall surface provided with a plurality of nozzles.

2. The high-pressure-water toothbrush of claim 1, wherein the first channel is provided with a water switch.

3. The high-pressure-water toothbrush of claim 1, wherein at least one of the nozzles is provided therein with a spiral duct or has a bore wall formed with a spiral groove.

4. The high-pressure-water toothbrush of claim 1, where at least one of the nozzles is provided thereabout with a plurality of bristles.

5. The high-pressure-water toothbrush of claim 1, wherein the first sidewall and the second sidewall form a mirror-symmetric structure.

6. The high-pressure-water toothbrush of claim 1, further comprising an extension tube connected between the handle and the U-shaped jet-washing groove structure, wherein the extension tube is provided therein with a third channel in communication with the first channel and the second channel.

7. The high-pressure-water toothbrush of claim 1, wherein the first sidewall is a dental arch-shaped structure, and the second sidewall is a fan-shaped jet-ejecting structure.

8. A U-shaped jet-washing groove structure, comprising a first sidewall and a second sidewall facing the first sidewall, wherein each of the first sidewall and the second sidewall has an inner wall surface provided with a plurality of nozzles.

9. The U-shaped jet-washing groove structure of claim 8, wherein at least one of the nozzles is provided therein with a spiral duct or has a bore wall formed with a spiral groove.

10. The U-shaped jet-washing groove structure of claim 8, wherein at least one of the nozzles is provided thereabout with a plurality of bristles.

11. The U-shaped jet-washing groove structure of claim 8, wherein the first sidewall and the second sidewall form a mirror-symmetric structure.

12. The U-shaped jet-washing groove structure of claim 8, wherein the first sidewall is a dental arch-shaped structure, and the second sidewall is a fan-shaped jet-ejecting structure.
